(19) United States
(12) Patent Application Publication
(10) Pub. No.: US 2024/0364129 A1
(43) Pub. Date: Oct. 31, 2024

(54) CHARGING CONTROL INTEGRATED CIRCUIT AND OPERATION METHOD THEREOF

(71) Applicant: SAMSUNG ELECTRONICS CO., LTD., SUWON-SI (KR)

(72) Inventor: TAEJIN JEONG, SUWON-SI (KR)

(21) Appl. No.: 18/420,547

(22) Filed: Jan. 23, 2024

(30) Foreign Application Priority Data
Apr. 25, 2023 (KR) 10-2023-0054272
Jul. 5, 2023 (KR) 10-2023-0087045

(51) Int. Cl. H02J 7/00

(52) U.S. Cl. CPC H02J 7/007182

(57) ABSTRACT

A charging control integrated circuit includes a direct charging circuit connected to an external system load, a first current limiting circuit connected between a first external battery and the direct charging circuit and operates in response to a first charging control signal, and a control circuit that controls the first charging control signal based on a system voltage corresponding to the external system load and a first battery voltage of the first external battery. When the external system load occurs while the first external battery is charged, the control circuit controls the first charging control signal so that a first voltage difference of the system voltage corresponding to the external system load and the first battery voltage of the first external battery is maintained at a reference level.

### CROSS-REFERENCE TO RELATED APPLICATIONS

This patent application claims priority under 35 U.S.C. § 119 to Korean Patent Application Nos. 10-2023-0054272 filed on Apr. 25, 2023, and 10-2023-0087045 filed on Jul. 5, 2023, in the Korean Intellectual Property Office, the disclosures of which are incorporated by reference in their entireties herein.

### 1. TECHNICAL FIELD

Embodiments of the present disclosure described herein are generally directed to an electronic device, and more particularly directed to a charging control integrated circuit and an operation method thereof.

A mobile device such as a smartphone, a digital camera, or a wearable device is powered by a battery for portability. As the performance of the mobile devices increases, so does power consumption of the mobile device. Thus, a capacity of the battery included in the mobile device may increase.

Various charging methods are used to efficiently charge the battery included in the mobile device. However, while the battery is charged, the battery charging may become unstable due to various external factors, thereby causing a reduction in performance or lifetime of the battery or a reduction in safety of a user of the mobile device.

### SUMMARY

At least one embodiment of the present disclosure provides a charging control integrated circuit with increased performance, increased reliability, and/or increased safety and an operation method thereof.

According to an embodiment, a charging control integrated circuit includes a direct charging circuit, a first current limiting circuit, and a control circuit. The direct charging circuit is connected to an external system load. The first current limiting circuit is connected between a first external battery and the direct charging circuit and operates in response to a first charging control signal. The control circuit controls the first charging control signal based on a system voltage corresponding to the external system load and a first battery voltage of the first external battery. When the external system load occurs while the first external battery is charged, the control circuit controls the first charging control signal so that a first voltage difference between the system voltage corresponding to the external system load and the first battery voltage of the first external battery is maintained at a reference level.

According to an embodiment, a charging control integrated circuit includes a current limiting circuit and a control circuit. The current limiting circuit limits a charging current to an external battery or a discharging current from the external battery in response to a charging control signal. The control circuit controls the charging control signal based on a battery voltage of the external battery. When a system voltage of an external system load connected to the charging control integrated circuit is lower than the battery voltage of the external battery, the control circuit controls the charging control signal so that a voltage difference between the system voltage and the battery voltage is maintained at a reference level.

According to an embodiment, an operation method of a charging control integrated circuit which includes a current limiting circuit configured to limit a charging current provided to an external battery includes: performing a charging operation on the external battery based on a constant voltage mode; controlling a charging control signal provided to the current limiting circuit so that a voltage difference between the system voltage and the battery voltage maintains a constant level, when a system voltage of an external system load connected to the charging control integrated circuit is lower than a battery voltage of the external battery; and controlling a voltage of the charging control signal so that the battery voltage of the external battery has a constant level, when the system voltage is higher than the battery voltage.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a charging system according to an embodiment of the present disclosure.

FIG. 2 is a block diagram illustrating an electronic device of FIG. 1 in detail.

FIG. 3 is a block diagram illustrating a control block of FIG. 2.

FIG. 4 illustrates graphs for describing an operation of a control block of FIG. 3.

FIG. 5 is a circuit diagram illustrating a current limiting block of FIG. 2.

FIG. 6 is a diagram illustrating a constant voltage mode control circuit of FIG. 3.

FIG. 7 illustrates graphs for describing an operation of a charging control IC when a system load increases during charging in a constant voltage mode.

FIG. 8 is a flowchart for describing an operation of a control block of FIG. 3.

FIG. 9 is a block diagram illustrating a supplement mode control circuit of a control block operating based on the flowchart of FIG. 8.

FIG. 10 is a circuit diagram illustrating a supplement mode control circuit of FIG. 9 in detail.

FIG. 11 illustrates graphs for describing an operation of a supplement mode control circuit of FIG. 10.

FIG. 12 is a diagram for describing a constant current mode control circuit of FIG. 3.

FIG. 13 is a flowchart illustrating an operation of a constant current mode control circuit of FIG. 12.

FIG. 14 is a circuit diagram illustrating a constant current mode control circuit of FIG. 12 in detail.

FIGS. 15A and 15B are diagrams for describing an operation of a constant current mode control circuit of FIG. 14.

FIG. 16 is a diagram illustrating a reference voltage generator configured to generate various reference voltages used in a charging circuit IC of FIG. 1.

FIG. 17 is a block diagram illustrating an electronic device according to an embodiment of the present disclosure.

FIG. 18 is a diagram illustrating a system according to an embodiment of the present disclosure.

### DETAILED DESCRIPTION

Below, embodiments of the present disclosure will be described in detail and clearly to such an extent that one of ordinary skill in the art may implement the present disclosure.

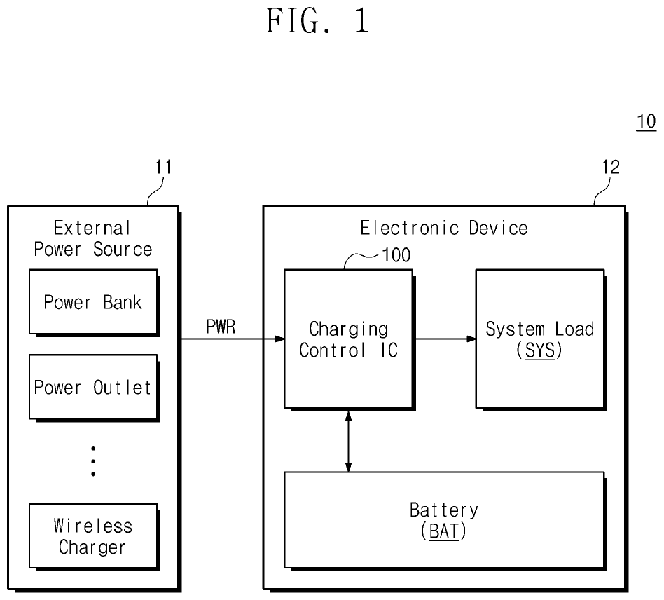

FIG. 1 is a block diagram illustrating a charging system according to an embodiment of the present disclosure. Referring to FIG. 1, a charging system 10 may include an external power source 11 and an electronic device 12. The external power source 11 may be configured to provide power PWR to the electronic device 12 through a wired or wireless scheme. For example, the external power source 11 may be various components, which are configured to provide the power PWR to the electronic device 12, such as a power bank, a power outlet, and a wireless charger.

The electronic device 12 may include various electronic devices that the user is able to carry. For example, the electronic device 12 may be at least one of various types of information processing systems or devices such as a mobile communication terminal, a personal digital assistant (PDA), a portable media player (PMP), a digital camera, a smartphone, a tablet computer, a laptop computer, and a wearable device. In an embodiment, the electronic device 12 may be a personal mobility device or an electric vehicle configured to operate using a power or a battery or may be an automotive electronic system included in the personal mobility device or the electric vehicle.

The electronic device 12 includes a charging control integrated circuit (IC) 100, a battery BAT, and a system load SYS. By using the power PWR from the external power source 11, the charging control IC 100 may charge the battery BAT or may provide the power to the system load SYS. In an embodiment, the charging control IC 100 is configured to charge the battery BAT based on a direct charging scheme. The direct charging scheme may refer to a way to directly provide the external power PWR to the battery BAT. The direct charging scheme may make it possible to increase the efficiency of power and to reduce the heating of the battery BAT. For example, the direct charging scheme may prevent the battery BAT from overheating or shorten a time needed to charge the battery BAT. However, the present disclosure is not limited thereto. For example, the charging control IC 100 may be configured to charge or control the battery BAT based on at least one of a direct charging scheme, a standard charging scheme, a fast charging scheme, and a switching charging scheme.

Under control of the charging control IC 100, the battery BAT may be charged or may provide power to the system load SYS. For example, when the electronic device 12 is connected to the external power source 11, the battery BAT may be provided with a charging current from the charging control IC 100. Alternatively, when the electronic device 12 is not connected to the external power source 11, the battery BAT may be configured to provide a discharging current to the system load SYS under control of the charging control IC 100. In an embodiment, when the system load SYS sharply increases in a state where the electronic device 12 is connected to the external power source 11, the battery BAT provides the discharging current to the system load SYS under control of the charging control IC 100.

In an embodiment, the battery BAT includes at least one battery cell. For example, the battery BAT may include a multi-cell battery with a serial connection structure, a parallel connection structure, or a serial-parallel connection structure. Alternatively, the battery BAT may include a single cell battery including one battery cell.

The system load SYS may include various components that are used or driven in the electronic device 12. For example, the system load SYS may include the remaining components of the electronic device 12 other than the charging control IC 100 and the battery BAT. For example, the system load SYS may include various chips, modules, operation blocks, function blocks, and intellectual property (IP) blocks such as a display, an application processor (AP), a camera module, a communication processor, a speaker, a memory, and storage. The system load SYS may operate based on the power from the charging control IC 100 or the battery BAT.

For example, the charging control IC 100 may be configured to control the charging current provided to the battery BAT or the discharging current output from the battery BAT, based on the charging status of the battery BAT or the status of the system load SYS. For example, the charging control IC 100 may include a current limiting block (e.g., a current limiting circuit) connected to the battery BAT. The current limiting block may be configured to limit or control the charging current provided to the battery BAT or the discharging current output from the battery BAT, based on the charging status of the battery BAT or the status of the system load SYS.

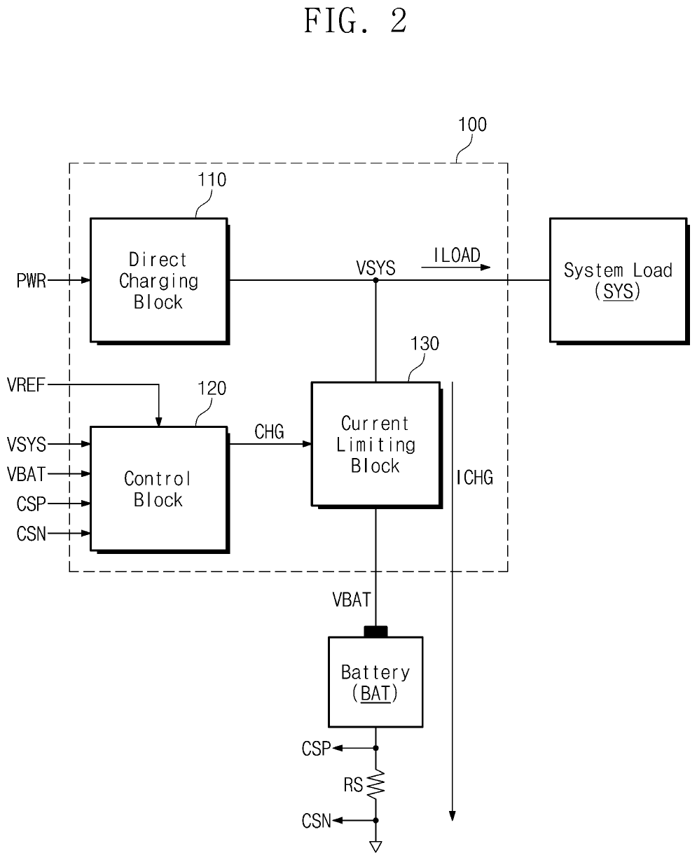

FIG. 2 is a block diagram illustrating an electronic device of FIG. 1 in detail according to an embodiment. In an embodiment, the charging control IC 100 will be described in detail with reference to FIG. 2. Referring to FIGS. 1 and 2, the electronic device 12 may include the charging control IC 100, the battery BAT, and the system load SYS. The battery BAT may be provided with a charging current ICHG from the charging control IC 100. In an embodiment, a sensing resistor RS is connected between the battery BAT and a node received a ground voltage. In an embodiment, the sensing resistor RS is used to sense the magnitude of the charging current ICHG.

The system load SYS may be provided with a load current ILOAD from the charging control IC 100. The system load SYS may operate based on the load current ILOAD. In an embodiment, when the system load SYS occurs or the magnitude of the system load SYS increases, the magnitude of the load current ILOAD may increase. As the magnitude of the load current ILOAD increases, the level of a system voltage VSYS may decrease.

The charging control IC 100 may include a direct charging block 110 (e.g., a direct charging circuit), a control block 120 (e.g., a control block circuit), and a current limiting block 130 (e.g., a current limiting block circuit). Based on the external power PWR from the external power source 11, the direct charging block 110 may charge the battery BAT or may provide the power to the system load SYS. In an embodiment, the direct charging block 110 charges the battery BAT in the direct charging scheme, but the present disclosure is not limited thereto.

The control block 120 may be configured to generate or control a charging control signal CHG based on the charging status of the battery BAT or the status of the system load SYS. For example, the control block 120 may determine the charging status of the battery BAT or the status of the system voltage VSYS, based on a plurality of reference voltages VREF, the system voltage VSYS, a battery voltage VBAT, a first sensing voltage CSP, and a second sensing voltage CSN. The system voltage VSYS may refer to a voltage of a node connected to the system load SYS. The battery voltage VBAT may refer to a voltage of a node connected to the battery BAT. In an embodiment, the system voltage VSYS and the battery voltage VBAT respectively refer to voltages at opposite ends of the current limiting block 130. The first sensing voltage CSP and the second sensing voltage CSN may respectively refer to voltages at opposite ends of the sensing resistor RS connected between the battery BAT and the ground voltage. The plurality of reference voltages VREF may refer to various reference voltages that are used to determine the status of the battery BAT and the status of the system voltage VSYS or to generate the charging control signal CHG.

In an embodiment, the control block 120 determines whether the system load SYS occurs, based on the system voltage VSYS and the battery voltage VBAT. When the system load SYS occurs under a specific condition, the control block 120 may control the charging control signal CHG so that a voltage difference between the system voltage VSYS and the battery voltage VBAT is maintained at a reference level.

In an embodiment, the control block 120 determines the charging status of the battery BAT based on the first sensing voltage CSP and the second sensing voltage CSN. When the charging current ICHG provided to the battery BAT sharply increases, the control block 120 may control the charging control signal CHG so that the charging current ICHG is maintained at a reference value or less. An operation of the control block 120 and an effect according to the operation will be described in detail with reference to the following drawings.

The current limiting block 130 may be connected between a node between the direct charging block 110 and the system load SYS (i.e., the node corresponding to the system voltage VSYS) and the battery BAT. The current limiting block 130 may control the charging current ICHG provided to the battery BAT from the direct charging block 110 in response to the charging control signal CHG from the control block 120.

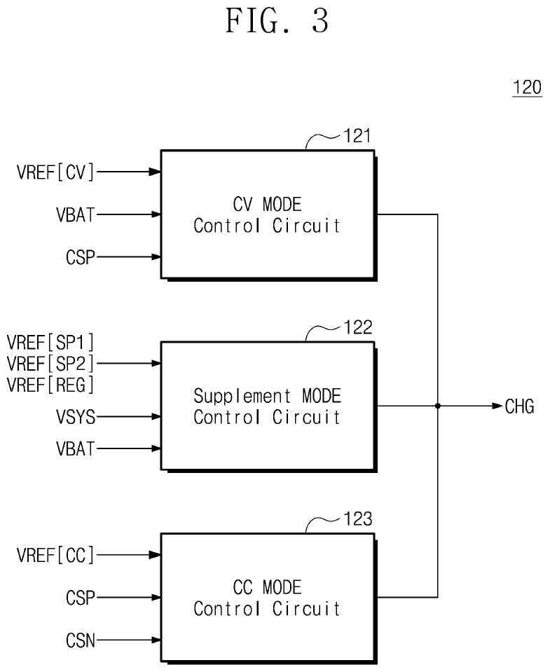

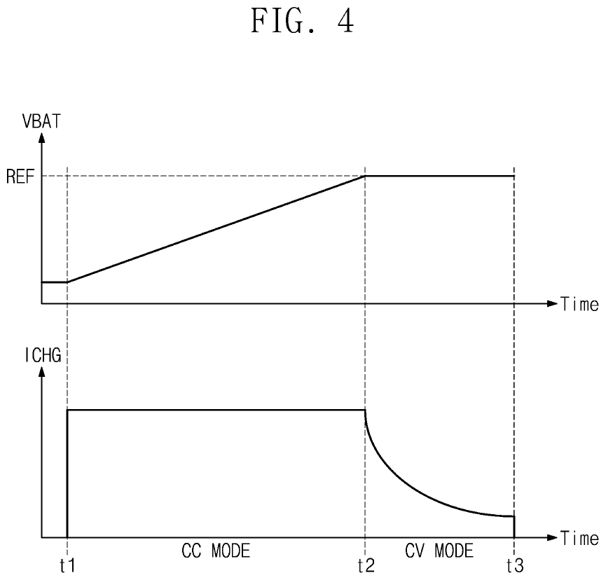

FIG. 3 is a block diagram illustrating a control block of FIG. 2. FIG. 4 illustrates graphs for describing an operation of a control block of FIG. 3. In the graphs of FIG. 4, horizontal axes represent a time, and vertical axes indicate the battery voltage VBAT and the charging current ICHG. Referring to FIGS. 1 to 4, the control block 120 may include a constant voltage mode (CV MODE) control circuit 121, a supplement mode control circuit 122, and a constant current mode (CC MODE) control circuit 123.

At least one of the constant voltage mode control circuit 121, the supplement mode control circuit 122, and the constant current mode control circuit 123 may control or generate the charging control signal CHG depending on a charging mode.

For example, the battery BAT may be charged in various modes, depending on charging states of the battery BAT. In detail, as illustrated in FIG. 4, the battery BAT may be charged by the charging current ICHG, and as the battery BAT is charged, the battery voltage VBAT may increase.

In this case, during the time period from t1 to t2 of FIG. 4, the battery voltage VBAT may be lower than a reference level REF. This means that the charging state of the battery BAT has not reached a reference state. In this case (i.e., when the battery voltage VBAT is lower than the reference level REF), the battery voltage VBAT may be charged based on a constant current mode (CC MODE). The constant current mode refers to a charging mode in which the battery BAT is charged by providing the charging current ICHG of a uniform or constant level to the battery BAT. In the constant current mode, since the uniform or constant charging current ICHG is provided to the battery BAT, the battery voltage VBAT may increase.

In an embodiment of the constant current mode, the constant current mode control circuit 123 of the control block 120 generates the charging control signal CHG based on a constant current reference voltages VREF[CC], the first sensing voltage CSP, and the second sensing voltage CSN. The current limiting block 130 may operate in response to the charging control signal CHG from the constant current mode control circuit 123. Thus, the level of the charging current ICHG may be uniformly or constantly maintained or may be maintained at the reference level REF or less.

At the second point in time t2 of FIG. 4, the battery voltage VBAT reaches the reference level REF. This means that the charging state of the battery BAT reaches the reference state. Alternatively, this means that the charging state of the battery BAT reaches a fully charged state. In this case (i.e., when the battery voltage VBAT reaches the reference level REF), the battery voltage VBAT is charged based on a constant voltage mode (CV MODE). The constant voltage mode may refer to a mode in which charging occurs in a state where the battery voltage VBAT is maintained at a uniform or constant level. In an embodiment of the constant voltage mode, the battery voltage VBAT is maintained at the uniform or constant level, and thus, the charging current ICHG may decrease.

In an embodiment of the constant voltage mode, the constant voltage mode control circuit 121 of the control block 120 generates the charging control signal CHG based on a constant voltage reference voltage VREF[CV], the battery voltage VBAT, and the first sensing voltage CSP. The current limiting block 130 may operate in response to the charging control signal CHG from the constant voltage mode control circuit 121. Thus, the level of the charging current ICHG may decrease.

Afterwards, at the third point in time t3, the battery BAT may be fully charged. Once the battery BAT is fully charged, the charging control signal CHG may be generated so that the charging current ICHG is blocked. For example, the charging control signal CHG may be generated to prevent the charging current ICHG from being suppliedto the battery BAT.

In an embodiment, while the battery BAT is charged in the constant voltage mode, when the system load SYS sharply increases, the load current ILOAD may not be sufficiently provided from the direct charging block 110 to the system load SYS. In this case, a discharging current may be generated from the battery BAT, and the discharging current from the battery BAT may be provided to the system load SYS as the load current ILOAD.

In an embodiment, a voltage difference between the system load SYS and the battery voltage VBAT may be variable depending on the status of the system load SYS (i.e., the magnitude of the load current ILOAD required). In this case, a switching toggle may be caused in the current limiting block 130. Alternatively, when the current limiting block 130 does not quickly operate (i.e., is quickly turned off) at the point in time when the system load SYS disappears, an excessive charging current ICHG may be provided to the battery BAT. In this case, a safety issue may occur in the battery BAT.

In a state where the battery BAT is charged in the constant voltage mode (CC mode) or the battery BAT is fully charged, the supplement mode control circuit 122 of the control block 120 may generate the charging control signal CHG based on a plurality of reference voltages VREF[SP1], VREF[SP2], and VREF[REG], the system voltage VSYS, and the battery voltage VBAT. The current limiting block 130 may operate in response to the charging control signal CHG from the supplement mode control circuit 122. In this case, when the system load SYS occurs, the voltage difference between the system load SYS and the battery voltage VBAT may maintain the reference voltage VREF[REF], and the switching toggle of the current limiting block 130 may be prevented. Also, when the charging control signal CHG is quickly discharged at a point in time when the system load SYS disappears, the current limiting block 130 may quickly operate. Thus, the charging current ICHG may be prevented from being generated unnecessarily. A configuration and an operation of the supplement mode control circuit 122 according to an embodiment of the present disclosure will be described in detail herein.

In an embodiment, when the battery voltage VBAT of the battery BAT does not reach the reference level REF or the battery BAT is charged in the constant current mode, the constant current mode control circuit 123 of the control block 120 may be activated (i.e., the constant current mode control circuit 123 may control the charging control signal CHG). When the battery voltage VBAT of the battery BAT reaches the reference level REF or the battery BAT is charged in the constant voltage mode, the constant voltage mode control circuit 121 or the supplement mode control circuit 122 of the control block 120 may be activated (i.e., the constant voltage mode control circuit 121 or the supplement mode control circuit 122 may control the charging control signal CHG). Alternatively, when the battery BAT is in a fully charged state, the supplement mode control circuit 122 of the control block 120 may be activated (i.e., the supplement mode control circuit 122 may control the charging control signal CHG).

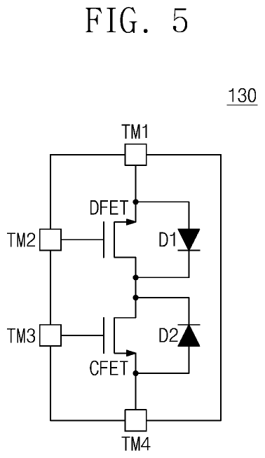

FIG. 5 is a circuit diagram illustrating the current limiting block 130 of FIG. 2 according to an embodiment. Referring to FIGS. 2 and 5, the current limiting block 130 may have a dual N-channel MOSFET structure. For example, the current limiting block 130 may include a first transistor DFET, a second transistor CFET, a first diode D1, and a second diode D2. Each of the first transistor DFET and the second transistor CFET may be an NMOS transistor. A source of the first transistor DFET may be connected to a first terminal TM1, a drain thereof may be connected to a drain of the second transistor CFET, and a gate thereof may be connected to a second terminal TM2. The drain of the second transistor CFET may be connected to the drain of the first transistor DFET, a source thereof may be connected to a fourth terminal TM4, and a gate thereof may be connected to a third terminal TM3. An anode and a cathode of the first diode D1 may be respectively connected to the source and the drain of the first transistor DFET. An anode and a cathode of the second diode D2 may be respectively connected to the source and the drain of the second transistor CFET.

In an embodiment, the third terminal TM3 is configured to receive the charging control signal CHG. In an embodiment, the first terminal TM1 and the second terminal TM2 is configured to be connected to the system voltage VSYS. In an embodiment, the fourth terminal TM4 is configured to be connected to the battery voltage VBAT.

The current limiting block 130 may operate in response to the charging control signal CHG received through the third terminal TM3. For example, when the level of the charging control signal CHG is greater than or equal to a threshold value (e.g., when the level of the charging control signal CHG is higher than the battery voltage VBAT), the current limiting block 130 may be turned on. That is, the magnitude of the charging current ICHG may be controlled or limited through the current limiting block 130 depending on the level of the charging control signal CHG. For example, the current limiting block 130 may operate to limit the charging current ICHG when it receives the charging control signal CHG at its third terminal TM3 that is greater than or equal to a threshold value.

The configuration of the current limiting block 130 described with reference to FIG. 5 is provided as an example, and the present disclosure is not limited thereto. The current limiting block 130 may be implemented with various forms of circuit structures configured to control or limit the charging current ICHG in response to the charging control signal CHG.

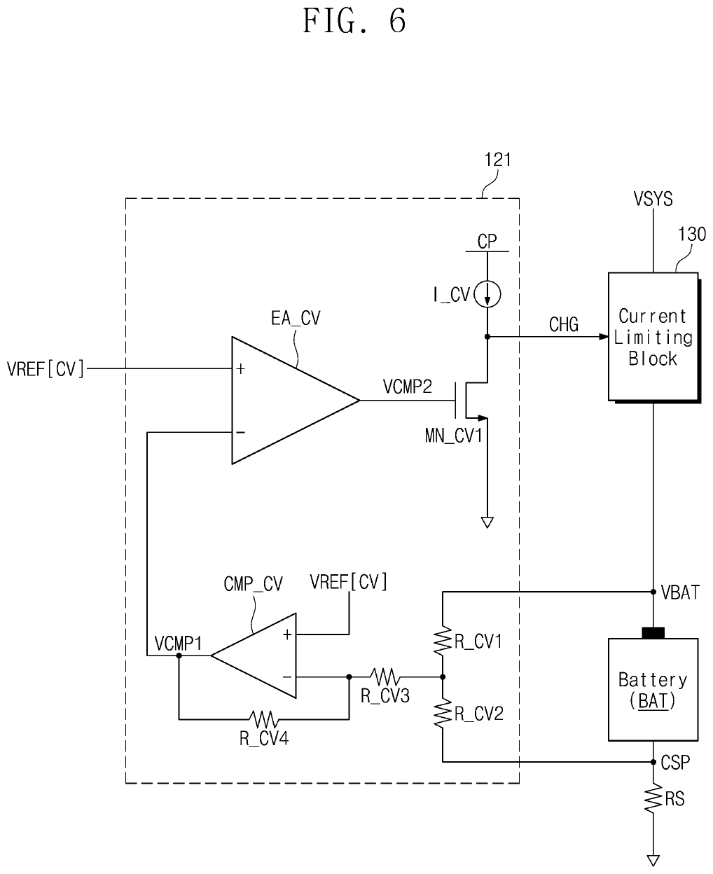

FIG. 6 is a diagram illustrating the constant voltage mode control circuit 121 of FIG. 3 according to an embodiment. For brevity of drawing and for convenience of description, components that are unnecessary to describe a constant voltage mode control circuit are omitted. Below, for convenience of description, a modifier of “CV” may be used to describe components included in the constant voltage mode control circuit 121. For example, the terms “NMOS transistor” and “CV error amplifier” may be used to refer to an NMOS transistor and an error amplifier included in the constant voltage mode control circuit 121. Alternatively, a resistor included in the supplement mode control circuit 122 may be referred to as an “SP resistor”. This is for distinguishing components included in different control circuits (e.g., a constant voltage mode control circuit, a supplement mode control circuit, and a constant current mode control circuit).

Referring to FIGS. 2, 3, and 6, the constant voltage mode control circuit 121 may generate the charging control signal CHG while the battery BAT is charged in the constant voltage mode. The current limiting block 130 may operate in response to the charging control signal CHG.

In an embodiment, the constant voltage mode control circuit 121 includes first to fourth CV resistors R_CV1 to R_CV4, a CV comparator CMP_CV (e.g., a comparator circuit), a CV error amplifier EA_CV, a CV current source I_CV, and a CV NMOS transistor MN_CV1.

The first and second CV resistors R_CV1 and R_CV2 may be connected in series between the opposite ends of the battery BAT (i.e., the battery voltage VBAT and the first sensing voltage CSP). The third CV resistor R_CV3 may be connected between a node between the first and second CV resistors R_CV1 and R_CV2 and an inverting input terminal (−) of the CV comparator CMP_CV. For example, one end of the third CV resistor R_CV3 may be connected to the node between the first and second CV resistors R_CV1 and R_CV2 and another end thereof may be connected to the inverting input terminal (−) of the CV comparator CMP_CV. The fourth CV resistor R_CV4 may be connected between the inverting input terminal (−) and an output terminal of the CV comparator CMP_CV. The CV reference voltage VREF[CV] may be provided to a non-inverting input terminal (+) of the CV comparator CMP_CV. The CV comparator CMP_CV may include an operational amplifier.

The output terminal of the CV comparator CMP_CV may be connected to an inverting input terminal (−) of the CV error amplifier EA_CV. The CV reference voltage VREF[CV] may be provided to a non-inverting input terminal (+) of the CV error amplifier EA_CV.

An output terminal of the CV error amplifier EA_CV may be connected to a gate of the CV NMOS transistor MN_CV1. A source of the CV NMOS transistor MN_CV1 may be connected to the ground voltage, and a drain thereof may be connected to the CV current source I_CV. The CV error amplifier EA_CV may include an operational amplifier. The charging control signal CHG may be output through the CV current source I_CV and the CV NMOS transistor MN_CV1.

The current limiting block 130 may operate in response to the charging control signal CHG generated through the constant voltage mode control circuit 121 illustrated in FIG. 6. In this case, the battery BAT may be charged based on the constant voltage mode.

For example, as the battery voltage VBAT increases, a voltage provided to the inverting input terminal (−) of the CV comparator CMP_CV may increase. In this case, a first comparison voltage VCMP1 being the output of the CV comparator CMP_CV may decrease. Because the first comparison voltage VCMP1 provided to the inverting input terminal (−) of the CV error amplifier EA_CV decreases, a second comparison voltage VCMP2 being the output of the CV error amplifier EA_CV may increase. The CV NMOS transistor MN_CV1 may be turned on by the increased second comparison voltage VCMP2, and thus, the level of the charging control signal CHG may become relatively low. The current limiting block 130 may further decrease the magnitude of the charging current ICHG in response to the charging control signal CHG whose level becomes relatively low. In this case, as the charging current ICHG decreases or is limited, the battery voltage VBAT may maintain a uniform or constant level.

That is, the constant voltage mode control circuit 121 may generate or control the charging control signal CHG so that the battery BAT is capable of being charged while the battery voltage VBAT maintains a uniform or constant level.

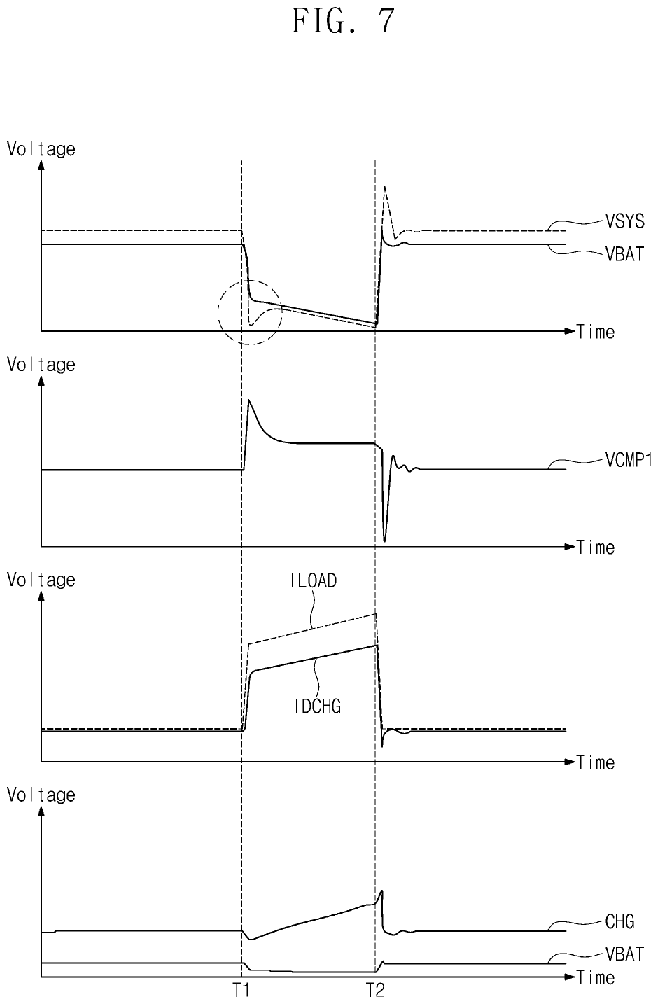

FIG. 7 illustrates graphs for describing an operation of a charging control integrated circuit (IC) when a system load increases during charging in a constant voltage mode. In FIG. 7, each horizontal axis represents a time, and each vertical axis represents a voltage.

Referring to FIGS. 6 and 7, the battery BAT may be charged based on the constant voltage mode. In this case, the system voltage VSYS, the battery voltage VBAT, and the first comparison voltage VCMP1 may maintain uniform or constant levels.

Afterwards, at the first point in time t1, the system load SYS may increase. As the system load SYS increases, the load current ILOAD may increase. As the load current ILOAD increases, the system voltage VSYS may sharply decrease. In this case, the system voltage VSYS may be lower than the battery voltage VBAT. Thus, a discharging current IDCHG may flow from the battery BAT toward the system load SYS. In an embodiment, the discharging current IDCHG that is a current flowing from the battery BAT toward the system load SYS is opposite in direction to the charging current ICHG. In an embodiment, the discharging current IDCHG and the charging current ICHG flow in opposite directions through the same path.

The battery voltage VBAT may decrease due to the discharging current IDCHG, and the first comparison voltage VCMP1 may increase due to the decrease in the battery voltage VBAT. In this case, the charging control signal CHG may increase. Afterwards, at the second point in time t2, the system load SYS may decrease or may be removed. Thus, the system voltage VSYS, the battery voltage VBAT, and the first comparison voltage VCMP1 may again maintain the uniform or constant levels.

In an embodiment, referring to the first point in time t1 of FIG. 7, assuming that the system load SYS occurs while the constant voltage mode control circuit 121 controls the charging control signal CHG, when the charging control signal CHG is not quickly controlled or driven, the system voltage VSYS may sharply decrease. In this case, an issue where the electronic device 12 is powered off may occur. While the load current ILOAD is illustrated in FIG. 7 as increasing linearly, the load current ILOAD may increase or decrease depending on the status of the system load SYS. Unlike the example illustrated in FIG. 7, when the load current ILOAD decreases in the time period from t1 to t2, the battery voltage VBAT may be higher than the system voltage VSYS; and in this case, the switching toggle may occur in the current limiting block 130.

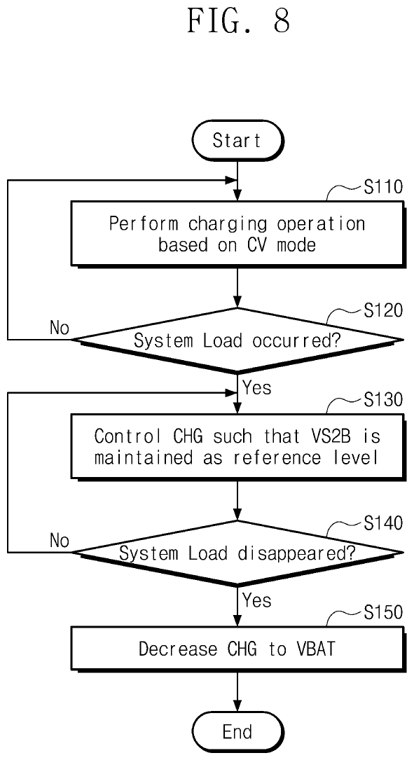

FIG. 8 is a flowchart for describing an operation of a control block of FIG. 3 according to an embodiment. In an embodiment, an operation of the constant voltage mode control circuit 121 of the control block 120 will be described with reference to FIG. 8. As described with reference to FIG. 3, in the constant voltage mode, when the system load SYS occurs, the supplement mode control circuit 122 may operate so that the discharging current IDCHG is stably provided and the unnecessary switching toggle of the current limiting block 130 is prevented. That is, the supplement mode control circuit 122 may operate in the constant voltage mode with regard to the battery BAT or may operate in a state where the battery BAT is fully charged.

Referring to FIGS. 3 and 8, in operation S110, the control block 120 performs the charging operation on the battery BAT based on the constant voltage mode. For example, when the battery voltage VBAT of the battery BAT reaches the reference level, the control block 120 may charge the battery BAT based on the constant voltage mode. In an embodiment, in the constant voltage mode, the control block 120 generates the charging control signal CHG so that the battery voltage VBAT of the battery BAT maintains a uniform or constant level.

In operation S120, the control block 120 determines whether the system load SYS occurs. For example, the control block 120 may determine whether the system load SYS occurs, based on the voltage difference between the system voltage VSYS and the battery voltage VBAT. For example, when the system load SYS occurs, the system voltage VSYS may be lower than the battery voltage VBAT due to the load current ILOAD provided to the system load SYS. In this case (i.e., when the system voltage VSYS is lower than the battery voltage VBAT), the control block 120 may determine that the system load SYS occurs.

When the system load SYS occurs, in operation S130, the control block 120 controls or generates the charging control signal CHG so that the voltage difference between the system voltage VSYS and the battery voltage VBAT is maintained at the reference level. For example, in the embodiment described with reference to FIGS. 6 and 7, as the load current ILOAD increases, the battery voltage VBAT may decrease; and in this case, the level of the charging control signal CHG may increase. That is, due to the decrease or change of the load current, the charging current may be again generated instead of the discharging current, thereby causing an overcharging issue.

In contrast, according to operation S130 of FIG. 8, even though the load current ILOAD increases or decreases due to the occurrence of the system load SYS, the control block 120 may control or generate the charging control signal CHG so that the voltage difference between the system voltage VSYS and the battery voltage VBAT is maintained at the reference level. In this case, even though the battery voltage VBAT decreases due to the discharging current IDCHG, the level of the charging control signal CHG may be uniformly or constantly maintained. Accordingly, even though there is no discharging current IDCHG due to the decrease or change of the load current, the issue that the battery BAT is overcharged may be prevented.

In operation S140, the control block 120 may determine whether the system load SYS disappears (or is no longer present). For example, the control block 120 may determine whether the system load SYS disappears, based on the voltage difference between the system voltage VSYS and the battery voltage VBAT. For example, even though the voltage difference between the system voltage VSYS and the battery voltage VBAT is maintained at the reference level under control of the control block 120 in operation S130, when the system load SYS disappears, the system voltage VSYS may be higher than the battery voltage VBAT. In this case, the control block 120 may determine that the system load SYS disappears or is no longer present.

When the system load SYS disappears, in operation S150, the control block 120 decreases the level of the charging control signal CHG to the battery voltage VBAT. As the level of the charging control signal CHG decreases to the battery voltage VBAT, the current limiting block 130 may be turned off. Thus, overcharging due to an additional charging current may be prevented. In an embodiment, the control block 120 is configured to charge the battery BAT in the constant voltage mode after the system load SYS disappears. For example, the control block 120 may be configured to charge the battery BAT in a buck mode in a state where the battery BAT is fully charged after the system load SYS disappears. In operation S140, when the control block 120 determines the system load SYS still occurs, the control block 120 may resume to operation S130.

As described above, according to an embodiment of the present disclosure, when the system load SYS occurs, the supplement mode control circuit 122 may quickly boost the charging control signal CHG. Thus, a sharp decrease in the system voltage VSYS may be prevented. Also, the supplement mode control circuit 122 may maintain the voltage difference between the system voltage VSYS and the battery voltage VBAT at a uniform or constant level. Thus, an unnecessary switching toggle of the current limiting block 130 may be prevented.

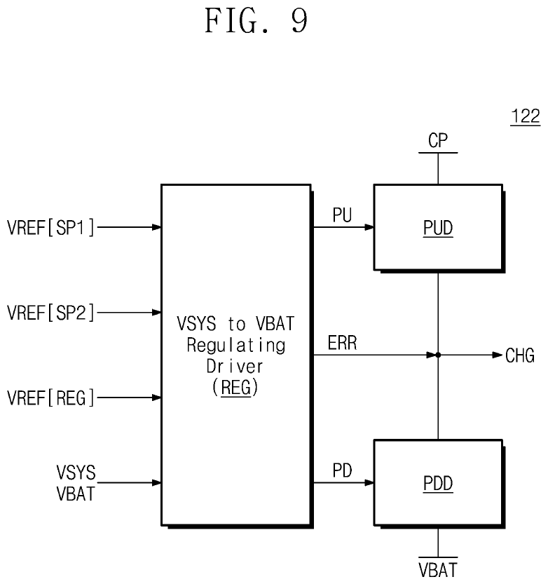

FIG. 9 is a block diagram illustrating the supplement mode control circuit 122 of the control block 120 operating based on the flowchart of FIG. 8 according to an embodiment. Referring to FIGS. 2, 3, and 9, when the battery BAT is charged in the constant voltage mode or the battery BAT is fully charged, the supplement mode control circuit 122 may be configured to control or generate the charging control signal CHG.

The supplement mode control circuit 122 may include a system voltage to battery voltage (VSYS to VBAT) regulating driver (for convenience of description, hereinafter referred to as a “regulating driver”) REG (e.g., a first driver circuit), a pull-up driver PUD (e.g., a second driver circuit), and a pull-down driver PDD (e.g., a third driver circuit).

The regulating driver REG may output a pull-up signal PU, a pull-down signal PD, and an error signal ERR, based on the plurality of reference voltages VREF[SP1], VREF[SP2], and VREF[REG], the system voltage VSYS, and the battery voltage VBAT. For example, when the system voltage VSYS is lower than the battery voltage VBAT (i.e., when the system load SYS occurs), the regulating driver REG may output the pull-up signal PU.

The pull-up driver PUD may increase the level of the charging control signal CHG up to a power supply voltage CP in response to the pull-up signal PU. In response to the charging control signal CHG whose level is increased to the power supply voltage CP, the current limiting block 130 may be turned on, and the discharging current IDCHG may be normally provided to the system load SYS.

In an embodiment, the regulating driver REG is configured to output an error signal ERR. The error signal ERR may be a signal for maintaining the voltage difference between the system voltage VSYS and the battery voltage VBAT at the reference level when the system voltage VSYS is lower than the battery voltage VBAT (i.e., when the system load SYS occurs). For example, the load current ILOAD may change due to the fluctuations of the system load SYS. As such, even though the system load SYS does not disappear, a case where the system voltage VSYS is higher than the battery voltage VBAT may occur. In this case, the level of the charging control signal CHG may be discharged to the battery voltage VBAT, and the current limiting block 130 may be turned off. However, when a state occurs where the system load SYS does not disappear, the charging control signal CHG may be again boosted to the power supply voltage CP, and the current limiting block 130 may be again turned on. That is, the change of the system voltage VSYS or the battery voltage VBAT due to the fluctuations of the system load SYS may cause the frequent switching toggle in the current limiting block 130.

In contrast, when the error signal ERR for maintaining the voltage difference between the system voltage VSYS and the battery voltage VBAT at the reference level is provided to the current limiting block 130 as a portion of the charging control signal CHG, the voltage difference between the system voltage VSYS and the battery voltage VBAT may be maintained at a uniform or constant level. Thus, the switching toggle of the current limiting block 130 may be prevented.

In an embodiment, as described with reference to FIGS. 6 and 7, in the constant voltage mode control circuit 121, when the system load SYS occurs, the battery voltage VBAT may decrease. Thus, the level of the charging control signal CHG may increase. However, when the charging control signal CHG depends on a bias current slew of the CV error amplifier EA_CV, the level of the charging control signal CHG does not quickly increase. That is, because the level of the charging control signal CHG fails to quickly increase as soon as the system load SYS occurs, the current limiting block 130 acts as a large resistor. Accordingly, the system voltage VSYS is considerably decreased as soon as the system load SYS occurs. In contrast, according to the supplement mode control circuit 122 of FIG. 9, because the level of the charging control signal CHG quickly increases to the power supply voltage CP as soon as the system voltage VSYS becomes lower than the battery voltage VBAT, a voltage drop of the system voltage VSYS may be prevented.

In an embodiment, even though the charging control signal CHG is controlled by the supplement mode control circuit 122, when the system load SYS disappears, the system voltage VSYS may become higher than the battery voltage VBAT. In this case, the regulating driver REG may output the pull-down signal PD. For example, the regulating driver REG may output the pull-down signal PD when the system voltage VSYS becomes higher than the battery voltage VBAT. The pull-down driver PDD may decrease the level of the charging control signal CHG to the battery voltage VBAT in response to the pull-down signal PD. In an embodiment, when the level of the charging control signal CHG decreases to the battery voltage VBAT, the current limiting block 130 may be turned off. Thus, overcharging due to the charging current may be prevented.

In an embodiment, when the regulating driver REG outputs the pull-down signal PD, the regulating driver REG does not output the error signal ERR.

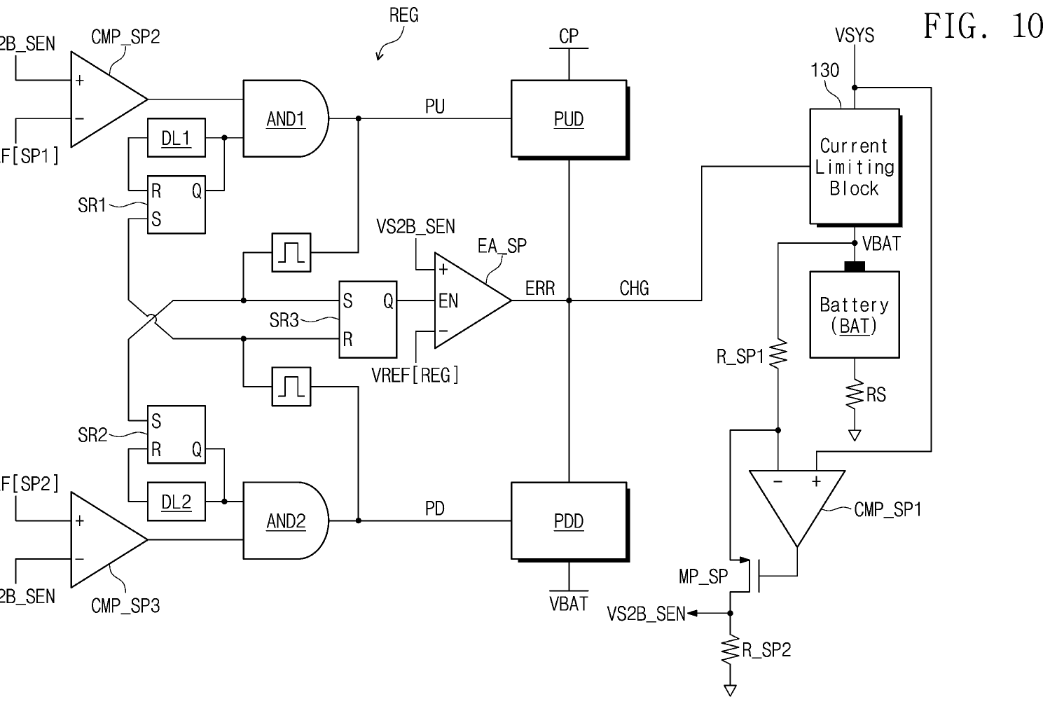

FIG. 10 is a circuit diagram illustrating a supplement mode control circuit of FIG. 9 in detail according to an embodiment. A part of the supplement mode control circuit 122 will be described as an example with reference to FIG. 10, and the present disclosure is not limited thereto. For example, when the system load SYS occurs under a specific condition (e.g., while the charging operation of the battery BAT is performed based on the constant voltage mode or when the battery BAT is in a fully charged state), the supplement mode control circuit 122 may control the charging control signal CHG so that the current limiting block 130 is quickly turned on and may control the charging control signal CHG so that the voltage difference between the system voltage VSYS and the battery voltage VBAT maintains a uniform or constant level. The supplement mode control circuit 122 according to an embodiment of the present disclosure may be implemented with various circuit structures that allow the above functions or operations to be performed.

Referring to FIGS. 9 and 10, the supplement mode control circuit 122 according to an embodiment includes a plurality of SP resistors R_SP1 and R_SP2, a first SP comparator CMP_SP1 (e.g., a comparator circuit), an SP PMOS transistor MP_SP, the regulating driver REG, the pull-up driver PUD, and the pull-down driver PDD.

A non-inverting input terminal (+) of the first SP comparator CMP_SP1 may be connected to the system voltage VSYS. The first SP resistor R_SP1 may be connected between an inverting input terminal (−) of the first SP comparator CMP_SP1 and the battery voltage VBAT. A source of the SP PMOS transistor MP_SP may be connected to the inverting input terminal (−) of the first SP comparator CMP_SP1, a drain thereof may be connected to the second SP resistor R_SP2, and a gate thereof may be connected to an output terminal of the first SP comparator CMP_SP1. The second SP resistor R_SP2 may be connected between the drain of the SP PMOS transistor MP_SP and the ground voltage. A VS2B sensing voltage VS2B_SEN may be output through a node between the second SP resistor R_SP2 and the SP PMOS transistor MP_SP. In an embodiment, the VS2B sensing voltage VS2B_SEN is a voltage corresponding to the voltage difference between the system voltage VSYS and the battery voltage VBAT.

In an embodiment, when the system voltage VSYS is higher than the battery voltage VBAT, the SP PMOS transistor MP_SP maintains a turn-off state in response to the output of the first SP comparator CMP_SP1. In this case, the VS2B sensing voltage VS2B_SEN may be the ground voltage.

When the system voltage VSYS is lower than the battery voltage VBAT, the SP PMOS transistor MP_SP may be turned on in response to the output of the first SP comparator CMP_SP1. In this case, the VS2B sensing voltage VS2B_SEN may increase. In an embodiment, as the voltage difference between the system voltage VSYS and the battery voltage VBAT increases, the VS2B sensing voltage VS2B_SEN increases.

In an embodiment, the regulating driver REG includes second and third SP comparators CMP_SP2 and CMP_SP3 (e.g., comparator circuits), first and second AND gates AND1 and AND2, first and second delay circuits DL1 and DL2, first to third latch circuits SR1, SR2, and SR3, and an SP error amplifier EA_SP. The comparators CMP_SP1, CMP_SP2, CMP_SP3 and the SP error amplifier EA_SP may each include an operational amplifier.

A non-inverting input terminal (+) of the second SP comparator CMP_SP2 may be connected to a node providing the VS2B sensing voltage VS2B_SEN, and an inverting input terminal (−) thereof may be connected to a node providing the first SP reference voltage VREF[SP1].

The first AND gate AND1 may receive an output of the second SP comparator CMP_SP2 and an output “Q” of the first latch circuit SR1 to perform an AND operation on the received outputs. In an embodiment, the output of the first AND gate AND1 is the pull-up signal PU. A non-inverting input terminal (+) of the third SP comparator CMP_SP3 may be connected to the second SP reference voltage VREF[SP2], and an inverting input terminal (−) thereof may be connected to a node providing the VS2B sensing voltage VS2B_SEN. In an embodiment, the first SP reference voltage VREF[SP1] is equal to the second SP reference voltage VREF[SP2]. Alternatively, the first SP reference voltage VREF[SP1] may be higher than the second SP reference voltage VREF[SP2]. The second AND gate AND2 may receive an output of the third SP comparator CMP_SP3 and an output of the second latch circuit SR2 to perform an AND operation on the received outputs. In an embodiment, the output of the second AND gate AND2 is the pull-down signal PD.

A set input terminal “S” of the first latch circuit SR1 may be connected to the output of the second AND gate AND2, and a reset input terminal “R” thereof may be connected to an output terminal “Q” of the first latch circuit SR1 through the first delay circuit DL1. A set input terminal “S” of the second latch circuit SR2 may be connected to the output of the first AND gate AND1, and a reset input terminal “R” thereof may be connected to an output terminal “Q” of the second latch circuit SR2 through the second delay circuit DL2. In an embodiment, the first latch circuit SR1 is configured to maintain the output of the second AND gate AND2 during a given time, and the second latch circuit SR2 is configured to maintain the output of the first AND gate AND1 during a given time.

A set input terminal “S” of the third latch circuit SR3 may be connected to the output of the first AND gate AND1, and a reset input terminal “R” thereof may be connected to the output of the second AND gate AND2. An output terminal “Q” of the third latch circuit SR3 may be connected to an enable terminal EN of the SP error amplifier EA_SP.

A non-inverting input terminal (+) of the SP error amplifier EA_SP may be connected to a node providing the VS2B sensing voltage VS2B_SEN, and an inverting input terminal (−) thereof may be connected to a node providing the regulating reference voltage VREF[REG]. The SP error amplifier EA_SP may output a difference between the VS2B sensing voltage VS2B_SEN and the regulating reference voltage VREF[REG] as the error signal ERR in response to an output signal of the output terminal “Q” of the third latch circuit SR3.

In an embodiment of the supplement mode control circuit 122 illustrated in FIG. 10, when the system load SYS occurs, the system voltage VSYS may become lower than the battery voltage VBAT. In this case, the VS2B sensing voltage VS2B_SEN increases through the operation of the first SP comparator CMP_SP1. Afterwards, when the VS2B sensing voltage VS2B_SEN is higher than the first SP reference voltage VREF[SP1], the pull-up signal PU is activated through the operations of the second SP comparator CMP_SP2 and the first AND gate AND1. The pull-up driver PUD may quickly boost the charging control signal CHG to the power supply voltage CP in response to the activated pull-up signal PU. In this case, the current limiting block 130 may be quickly turned on. Thus, a sharp voltage drop of the system voltage VSYS may be prevented.

Also, the output of the third latch circuit SR3 may be activated in response to the activated pull-up signal PU, and the SP error amplifier EA_SP may output the error signal ERR in response to the activated output of the third latch circuit SR3. In an embodiment, that the VS2B sensing voltage VS2B_SEN is higher than the regulating reference voltage VREF[REG] means that the voltage difference between the system voltage VSYS and the battery voltage VBAT is relatively great. Accordingly, when the VS2B sensing voltage VS2B_SEN is higher than the regulating reference voltage VREF[REG], the level of the error signal ERR may increase. In contrast, that the VS2B sensing voltage VS2B_SEN is lower than the regulating reference voltage VREF[REG] means that the voltage difference between the system voltage VSYS and the battery voltage VBAT is relatively small. Accordingly, when the VS2B sensing voltage VS2B_SEN is lower than the regulating reference voltage VREF[REG], the level of the error signal ERR may increase.

When the above error signal ERR is included in the charging control signal CHG, the turn-on state (or a turn-on level) of the current limiting block 130 may be controlled. Accordingly, the voltage difference between the system voltage VSYS and the battery voltage VBAT may be maintained at a uniform or constant level.

In an embodiment, when the system load SYS disappears, the system voltage VSYS may sharply increase. In this case, even though the control is made through the pull-up driver PUD and the SP error amplifier EA_SP, the system voltage VSYS may become higher than the battery voltage VBAT. According to the above description, in this case, the SP PMOS transistor MP_SP may be turned off through the operation of the first SP comparator CMP_SP1, and thus, the VS2B sensing voltage VS2B_SEN decreases. Afterwards, when the VS2B sensing voltage VS2B_SEN is lower than the second SP reference voltage VREF[SP2], the pull-down signal PD may be activated through the operations of the third SP comparator CMP_SP3 and the second AND gate AND2. The pull-down driver PDD may decrease the level of the charging control signal CHG to the battery voltage VBAT in response to the activated pull-down signal PD. The third latch circuit SR3 may be reset in response to the activated pull-down signal PD. In an embodiment, the SP error amplifier EA_SP does not operate when the output of the third latch circuit SR3 is reset.

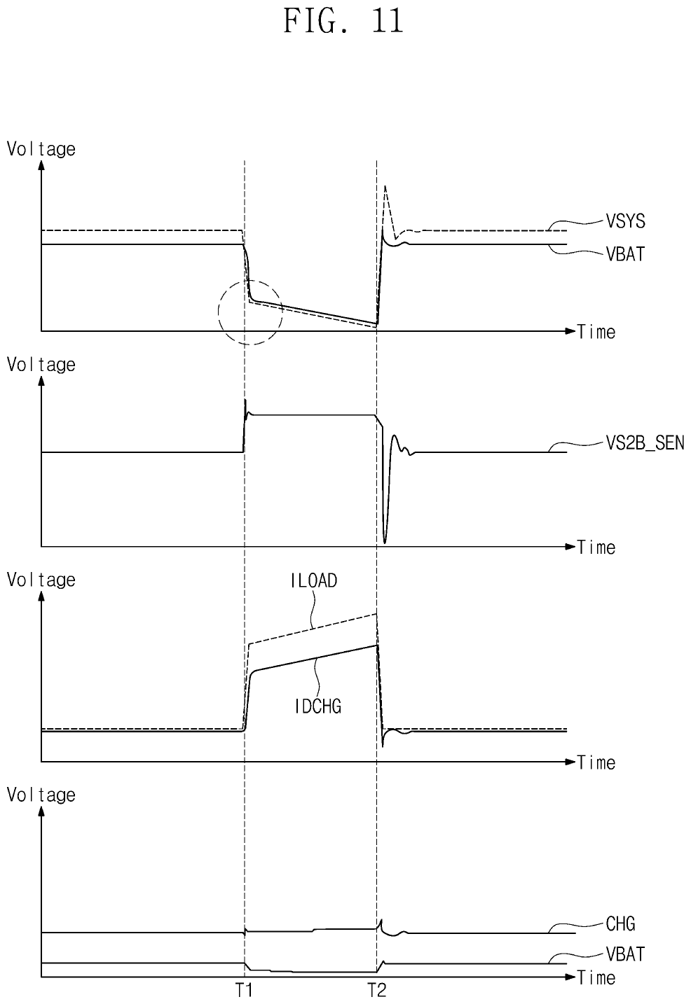

FIG. 11 illustrates graphs for describing an operation of the supplement mode control circuit of FIG. 10 according to an embodiment. In FIG. 11, each horizontal axis represents a time, and each vertical axis represents a voltage.

Referring to FIGS. 2, 10, and 11, the battery BAT may be charged based on the constant voltage mode (CV MODE). In this case, the battery voltage VBAT and the system voltage VSYS may maintain uniform or constant levels.

At the first point in time t1, the system load SYS may occur. In this case, as the load current ILOAD provided to the system load SYS increases, the system voltage VSYS may decrease. When the system voltage VSYS is lower than the battery voltage VBAT, as described with reference to FIG. 10, the VS2B sensing voltage VS2B_SEN may increase. Thus, the level of the charging control signal CHG may quickly increase to the power supply voltage CP. In this case, as described above, an excessive voltage drop of the system voltage VSYS may be prevented.

Also, the error signal ERR may be generated through the operation of the SP error amplifier EA_SP. When the error signal ERR is applied to the charging control signal CHG, the voltage difference between the system voltage VSYS and the battery voltage VBAT may be uniformly or constantly maintained while the system load SYS occurs. In this case, the switching toggle of the current limiting block 130 due to the fluctuations of the load current ILOAD may be prevented.

Afterwards, at the second point in time t2, the system load SYS may disappear. In this case, the system voltage VSYS may increase. When the system voltage VSYS is higher than the battery voltage VBAT, the VS2B sensing voltage VS2B_SEN may decrease. Thus, the level of the charging control signal CHG may quickly decrease to the battery voltage VBAT. As such, the current limiting block 130 may be turned off. That is, the battery BAT may be prevented from being overcharged.

As described above, according to an embodiment of the present disclosure, when the system load SYS occurs in a state where the battery BAT is charged based on the constant voltage mode or is fully charged, a quick supply of the discharging current IDCHG from the battery BAT to the system load SYS may be needed. However, in the constant voltage mode control circuit 121, to prevent the overcharging of the battery BAT, while it is possible to quickly turn off the current limiting block 130, it is difficult to quickly turn on the current limiting block 130 due to the characteristic of the constant voltage mode control circuit 121. In contrast, according to an embodiment of the present disclosure, when the system load SYS occurs in a state where the battery BAT is charged based on the constant voltage mode or is fully charged, the supplement mode control circuit 122 may quickly boost the charging control signal CHG to the power supply voltage CP. Thus, an excessive voltage drop of the system voltage VSYS may be prevented. Also, even though the system load SYS fluctuates, the error signal ERR may be generated through the operation of the SP error amplifier EA_SP. Thus, the voltage difference of the system voltage VSYS and the battery voltage VBAT may be uniformly or constantly maintained. In this case, the switching toggle of the current limiting block 130 due to the fluctuations of the system load SYS may be prevented.

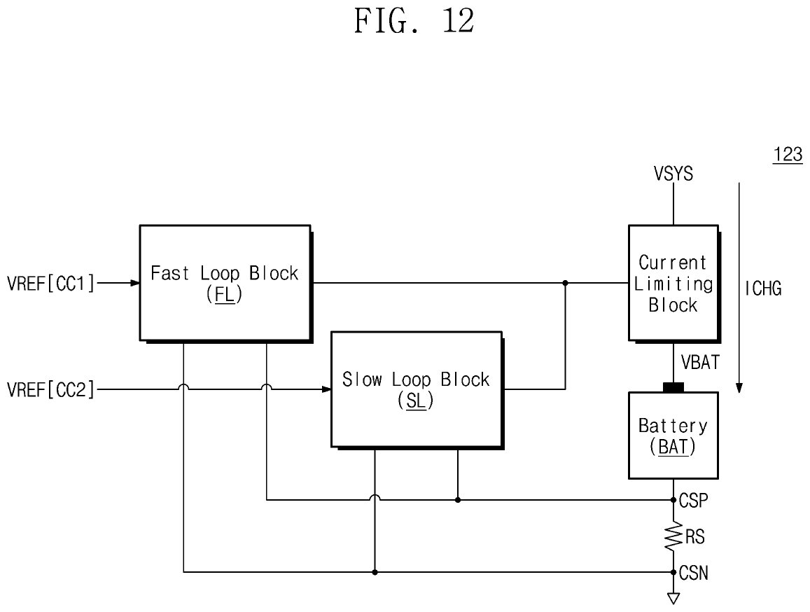

FIG. 12 is a diagram for describing the constant current mode control circuit of FIG. 3 according to an embodiment. Referring to FIGS. 3 and 12, the constant current mode control circuit 123 may be configured to uniformly or constantly maintain the charging current ICHG provided to the battery BAT. That is, the constant current mode control circuit 123 may control or generate the charging control signal CHG so that the battery BAT is charged based on the constant current mode.

In an embodiment, the constant current mode control circuit 123 includes a fast loop block FL (e.g., a first loop circuit) and a slow loop block SL (e.g., a second loop circuit). The fast loop block FL may control or generate the charging control signal CHG based on a first CC reference voltage VREF[CC1] and the voltages CSP and CSN at the opposite ends of the sensing resistor RS connected between the battery BAT and a node receiving the ground voltage. The slow loop block SL may generate the charging control signal CHG based on a second CC reference voltage VREF[CC2] and the voltages CSP and CSN at the opposite ends of the sensing resistor RS connected between the battery BAT and a node receiving the ground voltage. In an embodiment, the first CC reference voltage VREF[CC1] is higher than the second CC reference voltage VREF[CC2].

The fast loop block FL may be configured to quickly limit a sharp increase in the charging current ICHG. For example, in a situation where the system voltage VSYS sharply increases, the charging current ICHG may sharply increase due to the voltage difference between the system voltage VSYS and the battery voltage VBAT. In this case, a sensing voltage corresponding to a voltage difference between the voltages CSP and CSN at the opposite ends of the sensing resistor RS may be higher than the first CC reference voltage VREF[CC1]. In this case, the fast loop block FL may quickly decrease the level of the charging control signal CHG.

The slow loop block SL may be configured to maintain the charging current ICHG at a uniform or constant level. For example, the slow loop block SL may control the charging control signal CHG so that the sensing voltage corresponding to the voltage difference between the voltages CSP and CSN at the opposite ends of the sensing resistor RS is not greater than the second CC reference voltage VREF[CC2].

In an embodiment, the fast loop block FL is configured to quickly limit a sharp increase in the charging current ICHG, and the slow loop block SL is configured to compensate for the change in the charging current ICHG accurately.

In an embodiment, when the size of the sensing resistor RS (or a size of its resistance) connected between the battery BAT and a node receiving the ground voltage becomes larger, it may be easier to sense the charging current ICHG. However, when the size of the sensing resistor RS becomes larger, a power loss due to the sensing resistor RS may occur. For this reason, the size of the sensing resistor RS (or its resistance) may be relatively small to minimize the power loss. Because the voltage difference between the opposite ends of the sensing resistor RS with the small size is minute, a sensing circuit with a good noise characteristic may be needed to sense the change or increase of the charging current ICHG. However, as the noise characteristic of the sensing circuit becomes better, the response speed of the sensing circuit may become slower; and in this case, it may be impossible to cope with the sharp change in the charging current ICHG.

In this regard, according to an embodiment of the present disclosure, when the system voltage VSYS sharply increases while the battery BAT is charged based on the constant current mode, the charging current ICHG may sharply increase. In this case, the fast loop block FL may quickly sense an increase in the charging current ICHG and may quickly limit the increase in the charging current ICHG. The slow loop block SL may stably compensate for the change of the charging current ICHG or may maintain the charging current ICHG at a uniform or constant level.

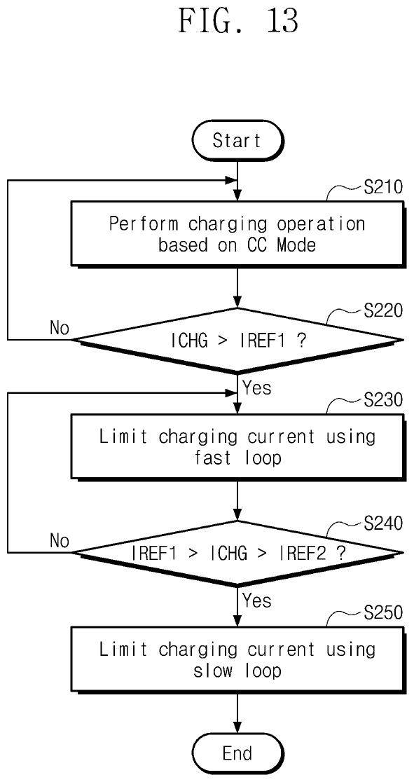

FIG. 13 is a flowchart illustrating an operation of the constant current mode control circuit of FIG. 12 according to an embodiment. Referring to FIGS. 12 and 13, in operation S210, the constant current mode control circuit 123 performs the charging operation on the battery BAT based on the constant current mode. For example, the constant current mode control circuit 123 may control or generate the charging control signal CHG so that the charging current ICHG is maintained at a uniform or constant level.

In operation S220, the constant current mode control circuit 123 determines whether the charging current ICHG is greater than a first reference current IREF1. For example, the fast loop block FL of the constant current mode control circuit 123 may determine whether the charging current ICHG is greater than the first reference current IREF1, based on the voltages CSP and CSN at the opposite ends of the sensing resistor RS through which the charging current ICHG flows. In an embodiment, the magnitude of the first reference current IREF1 corresponds to a combination of the first CC reference voltage VREF[CC1] and the structure of the sensing circuit included in the fast loop block FL. For example, the first reference current IREF1 may be based on the first CC reference voltage VREF[CC1] and the structure of the sensing circuit included in the fast loop block FL.

When the charging current ICHG is greater than the first reference current IREF1, in operation S230, the constant current mode control circuit 123 limits the charging current ICHG by using the fast loop block FL. For example, in response to that the charging current ICHG is greater than the first reference current IREF1, the fast loop block FL of the constant current mode control circuit 123 may control the charging control signal CHG so that the charging current ICHG decreases. In this case, the level of the charging control signal CHG may decrease. Thus, the current limiting block 130 may decrease the magnitude of the charging current ICHG. In an embodiment, the level of the charging current ICHG is controlled to correspond to the first reference current IREF1 by the fast loop block FL.

In operation S240, the constant current mode control circuit 123 may determine whether the charging current ICHG is smaller than the first reference current IREF1 and is greater than a second reference current IREF2. When the charging current ICHG is greater than the second reference current IREF2, in operation S250, the constant current mode control circuit 123 may limit the charging current ICHG by using the slow loop block SL.

For example, when the charging current ICHG is smaller than the first reference current IREF1, the fast loop block FL of the constant current mode control circuit 123 does not control the charging current ICHG. In this case, the slow loop block SL of the constant current mode control circuit 123 may determine whether the charging current ICHG is greater than the second reference current IREF2. When the charging current ICHG is greater than the second reference current IREF2, the slow loop block SL of the constant current mode control circuit 123 may control the charging current ICHG. In this case, in response to the charging control signal CHG controlled by the slow loop block SL of the constant current mode control circuit 123, the current limiting block 130 may decrease the charging current ICHG. In an embodiment, the level of the charging current ICHG is controlled to correspond to the second reference current IREF2 by the slow loop block SL of the constant current mode control circuit 123.

As described above, when the charging current ICHG sharply increases in a situation where the battery BAT is charged in the constant current mode, the fast loop block FL of the constant current mode control circuit 123 may quickly limit the charging current ICHG. Afterwards, the slow loop block SL of the constant current mode control circuit 123 may stably maintain or control the charging current ICHG at a uniform or constant level.

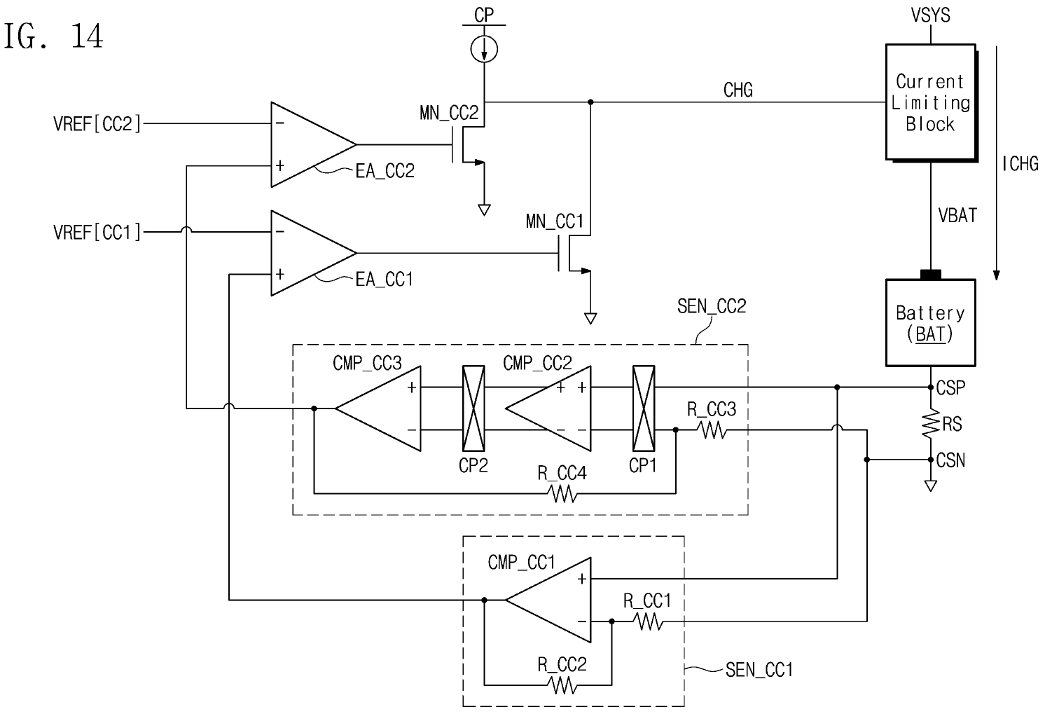

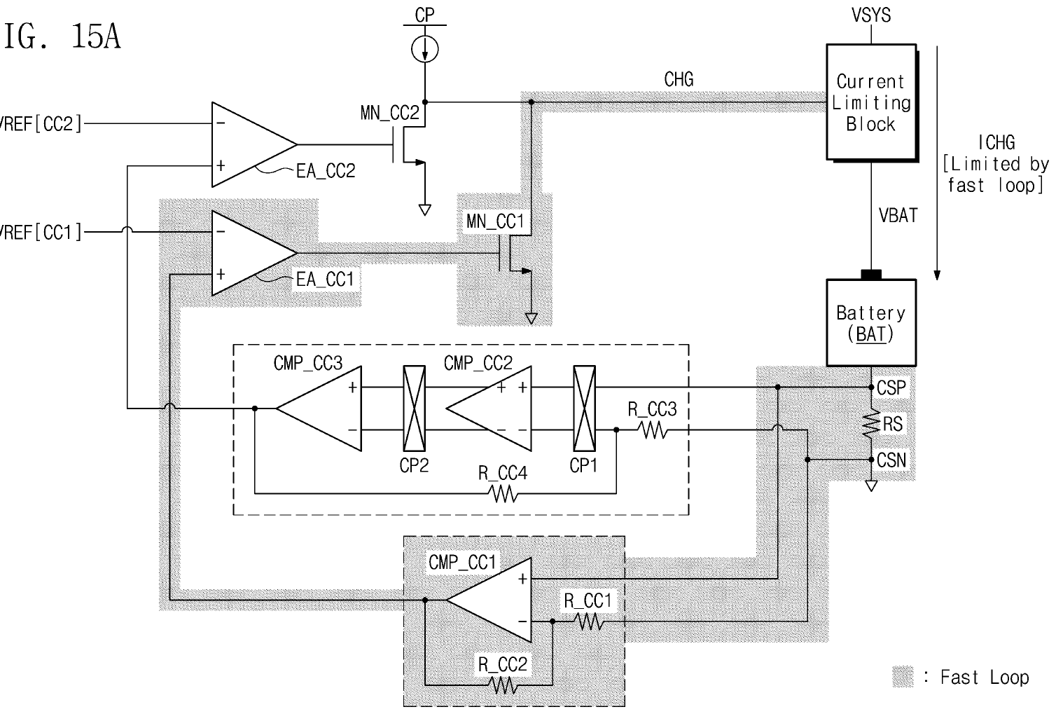

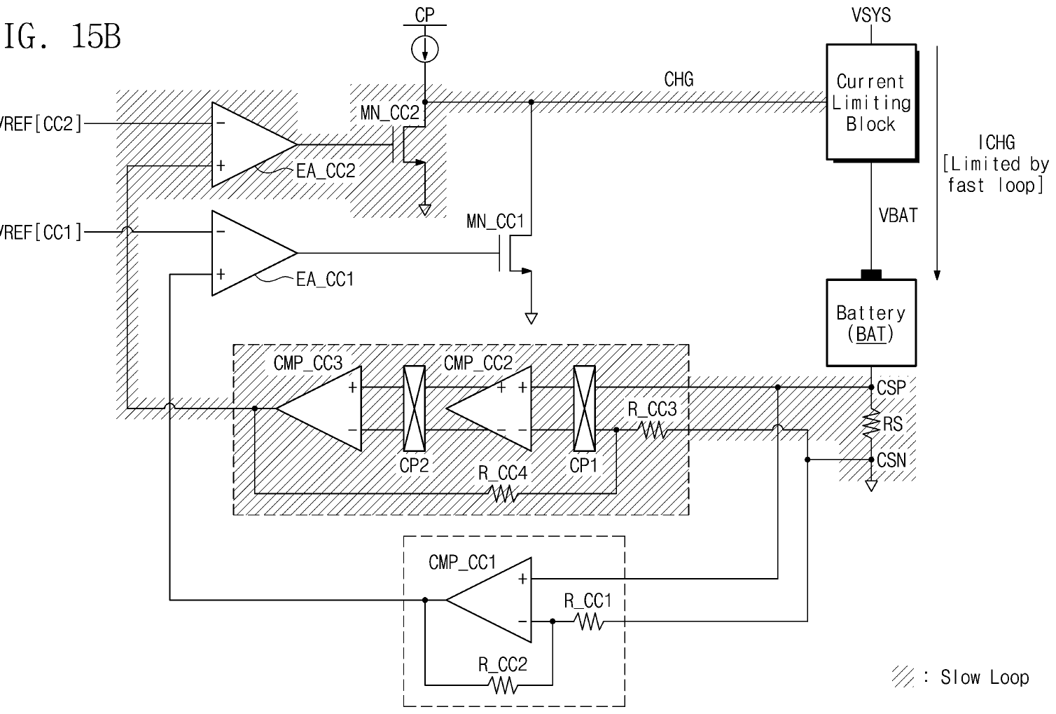

FIG. 14 is a circuit diagram illustrating the constant current mode control circuit of FIG. 12 in detail according to an embodiment. FIGS. 15A and 15B are diagrams for describing an operation of a constant current mode control circuit of FIG. 14. Referring to FIGS. 12, 14, 15A, and 15B, the constant current mode control circuit 123 may include the fast loop block FL and the slow loop block SL.

In an embodiment, the fast loop block FL includes a first CC sensing circuit SEN_CC1, a first CC error amplifier EA_CC1, and a first CC NMOS transistor MN_CC1. The first CC error amplifier EA_CC1 may include an operational amplifier. The first CC sensing circuit SEN_CC1 may include first and second CC resistors R_CC1 and R_CC2 and a first CC comparator CMP_CC1 (e.g., a comparator circuit). A non-inverting input terminal (+) of the first CC comparator CMP_CC1 may be connected to the first voltage CSP, and an inverting input terminal (−) thereof may be connected to a first end of the first CC resistor R_CC1. A second end of the first CC resistor R_CC1 may be connected to the second voltage CSN. The second CC resistor R_CC2 may be connected between the inverting input terminal (−) and an output terminal of the first CC comparator CMP_CC1.

An inverting input terminal (−) of the first CC error amplifier EA_CC1 may be connected to a node providing the first CC reference voltage VREF[CC1], and a non-inverting input terminal (+) thereof may be connected to the output terminal of the first CC sensing circuit SEN_CC1. An output terminal of the first CC error amplifier EA_CC1 may be connected to a gate of the first CC NMOS transistor MN_CC1. A drain of the first CC NMOS transistor MN_CC1 may be connected to a node from which the charging control signal CHG is output, and a source thereof may be connected to a node providing the ground voltage. A CC current source (e.g., a constant current source) may be connected between a node providing the power supply voltage CP and the node from which the charging control signal CHG is output.

In the above structure, as illustrated in FIG. 15A, the fast loop block FL may quickly control the charging control signal CHG. For example, the first CC sensing circuit SEN_CC1 may be configured to output a signal corresponding to voltages (e.g., CSP and CSN) at the opposite ends of the sensing resistor RS. In an embodiment, when the charging current ICHG increases, the voltage difference between the voltages (e.g., CSP and CSN) at the opposite ends of the sensing resistor RS may increase. Thus, the level of the output signal of the first CC sensing circuit SEN_CC1 may increase. In this case, the level of the output signal of the first CC sensing circuit SEN_CC1 may be higher than the first CC reference voltage VREF[CC1]. This means a state where the charging current ICHG excessively increases (or a state where the charging current ICHG is higher than the first reference current IREF1). In this case, the output signal of the first CC error amplifier EA_CC1 may increase. The first CC NMOS transistor MN_CC1 may be turned on in response to the output signal of the first CC error amplifier EA_CC1. Thus, the level of the charging control signal CHG may decrease. The current limiting block 130 may decrease the charging current ICHG in response to the charging control signal CHG whose level becomes low. Accordingly, the charging current ICHG that sharply increased may be quickly limited through the above operation.

In an embodiment, the slow loop block SL includes a second CC sensing circuit SEN_CC2, a second CC error amplifier EA_CC2, and a second CC NMOS transistor MN_CC2. The second CC error amplifier EA_CC2 may include an operational amplifier. The second CC sensing circuit SEN_CC2 may include third and fourth CC resistors R_CC3 and R_CC4, first and second chopping circuits CP1 and CP2, and second and third CC comparators CMP_CC2 and CMP_CC3. Each of the second and third CC comparators CMP_CC2 and CMP_CC3 may include an operational amplifier.

The third CC resistor R_CC3 may be connected between a node receiving the second voltage CSN and the first chopping circuit CPL. Input terminals of the first chopping circuit CP1 may be connected to a node receiving the first voltage CSP and the third CC resistor R_CC3. Input terminals (+) and (−) of the second CC comparator CMP_CC2 may be connected to output terminals of the first chopping circuit CP1. Output terminals of the second CC comparator CMP_CC2 may be connected to input terminals of the second chopping circuit CP2. Input terminals (+) and (−) of the third CC comparator CMP_CC3 may be connected to output terminals of the second chopping circuit CP2. The fourth CC resistor R_CC4 may be connected between an output terminal of the third CC comparator CMP_CC3 and the third CC resistor R_CC3.

The output terminal of the third CC comparator CMP_CC3 may be connected to a non-inverting input terminal (+) of the second CC error amplifier EA_CC2. An inverting input terminal (−) of the second CC error amplifier EA_CC2 may be connected to a node providing the second CC reference voltage VREF[CC2]. An output terminal of the second CC error amplifier EA_CC2 may be connected to a gate of the second CC NMOS transistor MN_CC2. A drain of the second CC NMOS transistor MN_CC2 may be connected to the node from which the charging control signal CHG is output, and a source thereof may be connected to a node providing the ground voltage.

In the above structure, as illustrated in FIG. 15B, the slow loop block SL may control the charging control signal CHG in response to the voltages CSP and CSN of the opposite ends of the sensing resistor RS. For example, when the charging current ICHG is greater than the second reference current IREF2, the output of the second CC sensing circuit SEN_CC2 may be greater than the second CC reference voltage VREF[CC2]. In this case, the output of the second CC error amplifier EA_CC2 may increase. Thus, the second CC NMOS transistor MN_CC2 may be turned on. As such, because the level of the charging control signal CHG decreases, the current limiting block 130 may limit the charging current ICHG.

In an embodiment, the first CC sensing circuit SEN_CC1 included in the fast loop block FL may have a fast operation characteristic compared to the second CC sensing circuit SEN_CC2 included in the slow loop block SL. That is, the first CC sensing circuit SEN_CC1 included in the fast loop block FL may quickly respond to the voltage difference between the voltages CSP and CSN at the opposite ends of the sensing resistor RS. In an embodiment, the second CC sensing circuit SEN_CC2 included in the slow loop block SL may provide higher accuracy compared to the first CC sensing circuit SEN_CC1 included in the fast loop block FL. For example, the second CC sensing circuit SEN_CC2 included in the slow loop block SL may include the first and second chopping circuits CP1 and CP2. Each of the first and second chopping circuits CP1 and CP2 may perform a chopping operation on input signals in response to a clock signal. As such, the second CC sensing circuit SEN_CC2 has relatively high reliability. In contrast, when a filter is used to remove glitch due to the chopping operation, the second CC sensing circuit SEN_CC2 has a slow operation characteristic.

In an embodiment, the magnitude of the charging current ICHG controlled or limited by the fast loop block FL is greater than the magnitude of the charging current ICHG controlled or limited by the slow loop block SL (e.g., the first reference current IREF1 may be greater than the second reference current IREF2). That is, when the charging current ICHG sharply increases, the charging current ICHG may be quickly limited to the first reference current IREF1 by the fast loop block FL. Afterwards, the charging current ICHG may be stably controlled to the second reference current IREF2 by the slow loop block SL.

As described above, according to an embodiment of the present disclosure, when the charging current ICHG sharply increases in a state where the battery BAT is charged in the constant current mode, the charging current ICHG may be quickly limited by the fast loop block FL, and the charging current ICHG may be stably limited by the slow loop block SL. Accordingly, the reliability and performance of the charging control IC 100 may be increased.

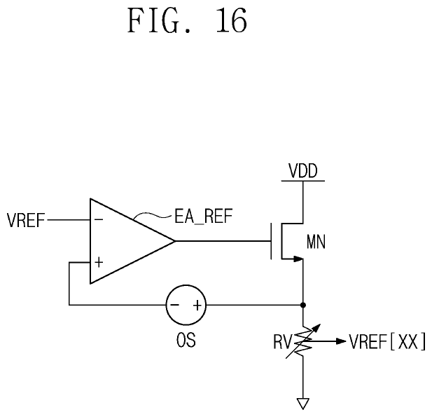

FIG. 16 is a diagram illustrating a reference voltage generator configured to generate various reference voltages used in a charging circuit IC of FIG. 1. In the above embodiments, various control blocks or various circuits may use various reference voltages. In this case, the reference voltages may be variously controlled or varied to be appropriate for an operation characteristic of each control block or each circuit.

Referring to FIG. 16, a reference voltage generator may include a reference error amplifier EA_REF, an NMOS transistor MN, an offset OS (e.g., a voltage source), and a variable resistor RV. The NMOS transistor MN and the variable resistor RV may be connected in series between a power supply voltage VDD and the ground voltage. One VREF[XX] voltage among various reference voltages (e.g., VREF[SP1], VREF[SP2], VREF[CC1], and VREF[CC2] described above) may be output through the variable resistor RV. A node between the NMOS transistor MN and the variable resistor RV may be connected to the offset OS. An inverting input terminal (−) of the reference error amplifier EA_REF may be connected to the reference voltage VREF, and a non-inverting input terminal (+) thereof may be connected to the offset OS. An output terminal of the reference error amplifier EA_REF may be connected to a gate of the NMOS transistor MN. The reference error amplifier EA_REF may include an operational amplifier.

In the structure of the reference voltage generator illustrated in FIG. 16, various reference voltages VREF[XX] may be generated by controlling the offset OS or the variable resistor RV by using the same reference voltage VREF. In an embodiment, the offset OS or the variable resistor RV is controlled so as to be appropriate for a control block or a circuit in which the reference voltage VREF[XX] is used.

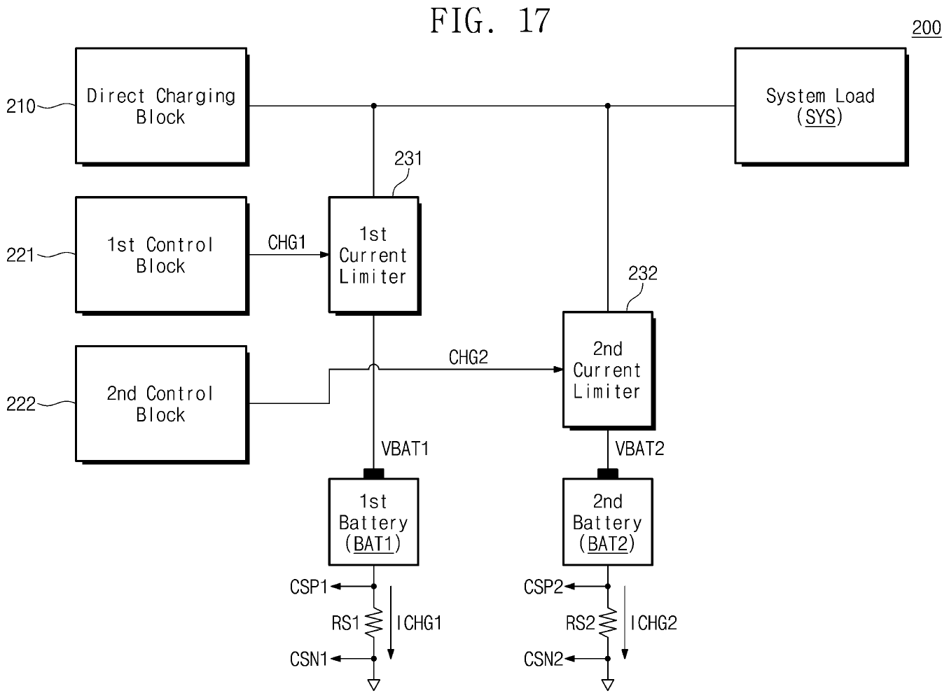

FIG. 17 is a block diagram illustrating an electronic device according to an embodiment of the present disclosure. Referring to FIG. 17, an electronic device may include a charging control IC 200, the system load SYS, a first battery BAT1, and a second battery BAT2. For convenience of description, additional description associated with the components described above will be omitted to avoid redundancy.

In an embodiment, the charging control IC 200 includes a direct charging block 210, a first control block 221, a second control block 222, a first current limiter 231 (e.g., a first current limiter circuit), and a second current limiter 232 (e.g., a second current limiter circuit). The direct charging block 210 may provide the load current to the system load SYS by using external power (or an external power source). The direct charging block 210 may provide a first charging current ICHG1 to the first battery BAT1 by using the external power. The direct charging block 210 may provide a second charging current ICHG2 to the second battery BAT2 by using the external power.

In an embodiment, the first control block 221 controls or generates a first charging control signal CHG1 based on the status of the first battery BAT1 and the status of the system load SYS. For example, the first control block 221 may determine the status of the first battery BAT1 and the status of the system load SYS based on the system voltage VSYS, a first battery voltage VBAT1, and voltages CSP1 and CSN1 at opposite ends a first sensing resistor RS1. The first control block 221 may control or generate the first charging control signal CHG1 based on the determined statuses and the determined voltages. The first sensing resistor RS1 may be connected between the first battery BAT1 and a node receiving the ground voltage.

The second control block 222 may control or generate a second charging control signal CHG2 based on the status of the second battery BAT2 and the status of the system load SYS. For example, the second control block 222 may determine the status of the second battery BAT2 and the status of the system load SYS based on the system voltage VSYS, a second battery voltage VBAT2, and voltages CSP2 and CSN2 at opposite ends of a second sensing resistor RS2. The second control block 222 may control or generate the second charging control signal CHG2 based on the determined statuses and the determined voltages. The second sensing resistor RS2 may be connected between the second battery BAT2 and a node receiving the ground voltage.

In an embodiment, the first and second control blocks 221 and 222 may respectively control or generate the first and second charging control signals CHG1 and CHG2 based on the method described with reference to FIGS. 1 to 16.

In an embodiment, the first control block 221 controls or generates the first charging control signal CHG1 based on the status of the second battery BAT2. For example, when the second battery BAT2 is in a fully charged state and the first battery BAT1 is being charged in the constant current mode, the first control block 221 may control or generate the first charging control signal CHG1 based on the method described with reference to FIGS. 12 to 15B so that the first charging current ICHG1 does not sharply increase. Alternatively, the second control block 222 may control or generate the second charging control signal CHG2 based on the status of the first battery BAT1. For example, when the first battery BAT1 is in a fully charged state and the second battery BAT2 is being charged in the constant current mode, the second control block 222 may control or generate the second charging control signal CHG2 based on the method described with reference to FIGS. 12 to 15B so that the second charging current ICHG2 does not sharply increase.

The first current limiter 231 may be connected between the direct charging block 210 and the first battery BAT1. The first current limiter 231 may limit or control the first charging current ICHG1 in response to the first charging control signal CHG1. The second current limiter 232 may be connected between the direct charging block 210 and the second battery BAT2. The second current limiter 232 may limit or control the second charging current ICHG2 in response to the second charging control signal CHG2.

In the embodiment, the electronic device includes a parallel battery system. As illustrated in FIG. 17, the electronic device may include the plurality of batteries BAT1 and BAT2, and the plurality of batteries BAT1 and BAT2 may be connected in parallel. In this case, when battery voltages VBAT1 and VBAT2 of the plurality of batteries BAT1 and BAT2 are different from each other, a charging current may sharply increase in a specific battery due to the voltage difference between the battery voltages VBAT1 and VBAT2. For example, various components of an electronic device may be manufactured through separate manufacturing processes and are then assembled in one electronic device. Assuming that the components are assembled in one electronic device in a situation where the first and second batteries BAT1 and BAT2 have different charging states, when the charging of the first and second batteries BAT1 and BAT2 is performed, a voltage difference may occur between the first and second batteries BAT1 and BAT2. When the first battery voltage VBAT1 is higher than the second battery voltage VBAT2, a current may be introduced to the second battery BAT2 from the first battery BAT1, thereby causing a sharp increase in the second charging current ICHG2. In this case, the charging control IC 200 may quickly limit the sharp increase in the second charging current ICHG2, as described with reference to FIGS. 1 to 16. Accordingly, the reliability, performance, and stability of the charging control IC 200, the first battery BAT1, and the second battery BAT2 may be increased.

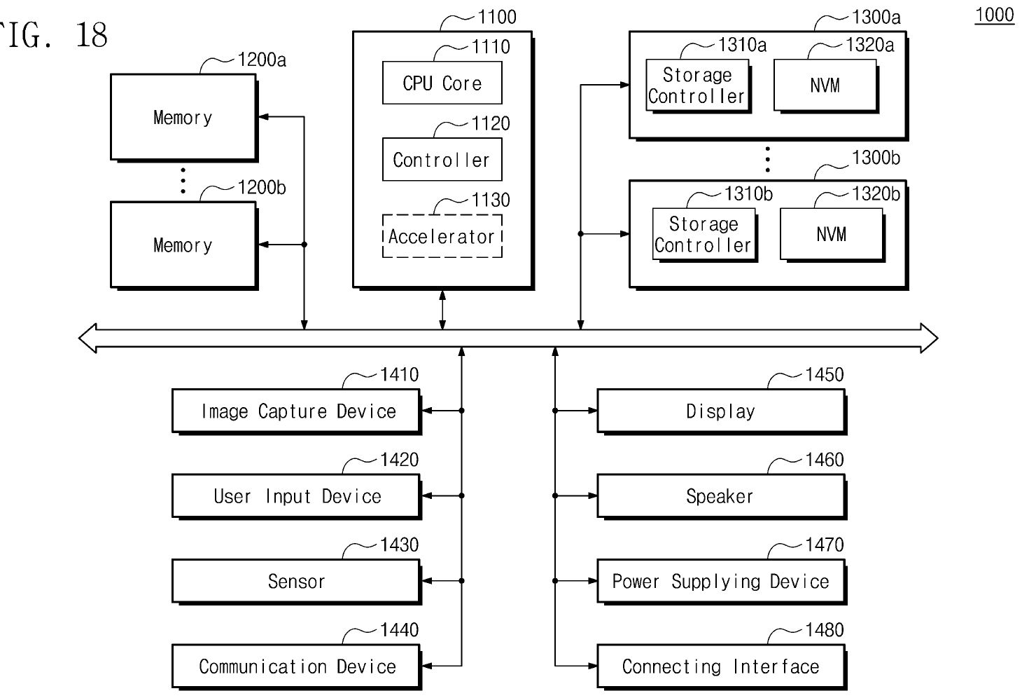

FIG. 18 is a diagram of a system 1000 according to an embodiment. The system 1000 of FIG. 18 may be a mobile system, such as a portable communication terminal (e.g., a mobile phone), a smartphone, a tablet personal computer (PC), a wearable device, a healthcare device, or an Internet of things (IoT) device. However, the system 1000 of FIG. 18 is not limited to the mobile system and may be a PC, a laptop computer, a server, a media player, or an automotive device (e.g., a navigation device).

Referring to FIG. 18, the system 1000 may include a main processor 100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers(STRG CTRL) 1310a and 1310b and NVM(Non-Volatile Memory)s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 1000 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery (not shown) embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

In an embodiment, the power supplying device 1470 includes the charging control IC and the battery described with reference to FIGS. 1 to 17. The power supplying device 1470 may charge the battery or may limit a charging current, based on the method described with reference to FIGS. 1 to 17.

According to the present disclosure, when a system load occurs while a battery is in a fully charged state or is being charged in a constant voltage mode, a charging control integrated circuit may quickly turn on a current limiting block. As such, as a discharging current is quickly provided as a load current, and thus, a sharp voltage drop in a system voltage may be prevented. Also, when the system load occurs, the charging control integrated circuit may maintain a voltage difference between the system voltage and a battery voltage at a uniform or constant level. Thus, unnecessary switching toggle of the current limiting block may be prevented.

In addition, when a charging current sharply increases while the battery is being charged in a constant current mode, the charging current may be quickly limited through a fast loop block, and afterwards, the charging current may be stably controlled at a reference level through a slow loop block.

Accordingly, a charging control integrated circuit with increased performance, increased reliability, and increased stability and an operation method thereof are provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A charging control integrated circuit comprising:
a direct charging circuit connected to an external system load;
a first current limiting circuit connected between a first external battery and the direct charging circuit, and configured to operate in response to a first charging control signal; and
a control circuit configured to control the first charging control signal based on a system voltage corresponding to the external system load and a first battery voltage of the first external battery,
wherein, when the external system load occurs while the first external battery is charged, the control circuit controls the first charging control signal so that a first voltage difference between the system voltage corresponding to the external system load and the first battery voltage of the first external battery is maintained at a reference level.

2. The charging control integrated circuit of claim 1, wherein the control circuit comprises:
a constant voltage mode control circuit configured to control the first charging control signal so that the first external battery is charged in a constant voltage mode;
a constant current mode control circuit configured to control the first charging control signal so that the first external battery is charged in a constant current mode; and
a supplement mode control circuit,
wherein, when the external system load occurs, the supplement mode control circuit is configured to control the first charging control signal so that the first voltage difference of the system voltage and the first battery voltage is maintained at the reference level.

3. The charging control integrated circuit of claim 2, wherein, when the first battery voltage of the first external battery is lower than a reference voltage, the constant current mode control circuit is activated, and
wherein, when the first battery voltage of the first external battery is not lower than the reference voltage, the constant voltage mode control circuit or the supplement mode control circuit is activated.

4. The charging control integrated circuit of claim 2, wherein the supplement mode control circuit is activated when the system voltage is lower than the battery voltage.

5. The charging control integrated circuit of claim 2, wherein the supplement mode control circuit comprises:
a first sensing circuit configured to output a first sensing signal corresponding to a voltage difference between the system voltage and the battery voltage, based on the system voltage and the battery voltage;
a regulating circuit configured to generate a pull-up signal, a pull-down signal, and an error signal based on a first reference voltage, a second reference voltage, a third reference voltage, and the first sensing signal;
a pull-up driver configured to boost the first charging control signal to a power supply voltage in response to the pull-up signal; and
a pull-down driver configured to decrease a voltage of the first charging control signal to the first battery voltage.

6. The charging control integrated circuit of claim 5, wherein, when a voltage of the first sensing signal is higher than the first reference voltage, the regulating circuit outputs the pull-up signal and the error signal,
wherein, when the voltage of the first sensing signal is lower than the second reference voltage, the regulating circuit outputs the pull-down signal, and
wherein the first reference voltage is higher than the second reference voltage.

7. The charging control integrated circuit of claim 6, wherein the error signal is a signal for compensating for a difference between the voltage of the first sensing signal and the third reference voltage.

8. The charging control integrated circuit of claim 5, wherein the regulating circuit comprises:
a first comparator configured to compare the voltage of the first sensing signal and the first reference voltage to output a first comparison result;
a second comparator configured to compare the voltage of the first sensing signal and the second reference voltage to output a second comparison result;
a first latch circuit including a set input terminal receiving the pull-down signal;
a first delay circuit connected between an output terminal of the first latch circuit and a reset input terminal of the first latch circuit;
a first AND gate configured to output the pull-up signal based on an output of the output terminal of the first latch circuit and the first comparison result;
a second latch circuit including a set input terminal receiving the pull-up signal;
a second delay circuit connected between an output terminal of the second latch circuit and a reset input terminal of the second latch circuit;
a second AND gate configured to output the pull-down signal based on an output of the output terminal of the second latch circuit and the second comparison result;
a third latch circuit including a set input terminal receiving the pull-up signal and a reset input terminal receiving the pull-down signal; and
an error amplifier configured to be activated in response to an output of the third latch circuit and to output the error signal as a result of comparing the voltage of the first sensing signal and the third reference voltage.

9. The charging control integrated circuit of claim 2, wherein the constant current mode control circuit comprises:
a fast loop circuit configured to control the first charging control signal based on a fourth reference voltage and voltages of opposite ends of a sensing resistor connected between the first external battery and a ground voltage; and
a slow loop circuit configured to control the first charging control signal based on a fifth reference voltage and the voltages of the opposite ends of the sensing resistor, and
wherein the fourth reference voltage is higher than the fifth reference voltage.

10. The charging control integrated circuit of claim 9, wherein the current limiting circuit is configured to:
limit the charging current to a magnitude of a first reference current in response to the first charging control signal controlled by the fast loop circuit and
limit the charging current to a magnitude of a second reference current in response to the first charging control signal controlled by the slow loop circuit, and
wherein the magnitude of the second reference current is less than the magnitude of the first reference current.

11. The charging control integrated circuit of claim 9, wherein the constant current mode control circuit further comprises:
a current source connected between a power supply voltage and an output node,
wherein the fast loop block comprises:
a second sensing circuit configured to output a second sensing signal based on the voltages of the opposite ends of the sensing resistor;
a second error amplifier configured to output a second error signal as a result of comparing the second sensing signal and the fourth reference voltage;
a first N-channel metal-oxide semiconductor (NMOS) transistor including a drain terminal connected to the output node, a source terminal connected to a ground node, and a gate terminal receiving the second error signal, and
wherein the slow loop block comprises:
a third sensing circuit configured to output a third sensing signal based on the voltages of the opposite ends of the sensing resistor;
a third error amplifier configured to output a third error signal as a result of comparing the third sensing signal and the fifth reference voltage; and
a second NMOS transistor including a drain terminal connected to the output node, a source terminal connected to the ground node, and a gate terminal receiving the third error signal.

12. The charging control integrated circuit of claim 11, wherein the second sensing circuit of the fast loop circuit has a faster response characteristic than the first sensing circuit of the slow loop circuit.

13. The charging control integrated circuit of claim 1, further comprising:
a second current limiting circuit connected between a second external battery and the direct charging circuit, and configured to operate in response to a second charging control signal,
wherein the control circuit is further configured to control the second charging control signal based on the system voltage of the external system load and a second battery voltage of the second external battery.

14. The charging control integrated circuit of claim 13, wherein each of the first current limiting circuit and the second current limiting circuit has a dual N-channel metal-oxide-semiconductor field-effect transistor (MOSFET) structure.

15. A charging control integrated circuit comprising:
a current limiting circuit configured to limit a charging current to an external battery or a discharging current from the external battery in response to a charging control signal; and
a control circuit configured to control the charging control signal based on a battery voltage of the external battery,
wherein, when a system voltage of an external system load connected to the charging control integrated circuit is lower than the battery voltage of the external battery, the control circuit controls the charging control signal so that a voltage difference between the system voltage and the battery voltage is maintained at a reference level.

16. The charging control integrated circuit of claim 15, wherein the control circuit is configured to:
when the battery voltage of the external battery does not reach a reference voltage, control the charging control signal so that the external battery is charged based on a constant current mode; and
when the battery voltage of the external battery reaches the reference voltage, control the charging control signal so that the external battery is charged based on a constant voltage mode.

17. The charging control integrated circuit of claim 16, wherein the control circuit is configured to:
when the system voltage of the external system load is higher than the battery voltage of the external battery, control the charging control signal so that the external battery is charged based on the constant voltage mode.

18. An operation method of a charging control integrated circuit which includes a current limiting circuit configured to limit a charging current provided to an external battery, the method comprising:
performing a charging operation on the external battery based on a constant voltage mode;
when a system voltage of an external system load connected to the charging control integrated circuit is lower than a battery voltage of the external battery, controlling a charging control signal provided to the current limiting circuit so that a voltage difference between the system voltage and the battery voltage maintains a constant level; and
when the system voltage is higher than the battery voltage, controlling a voltage of the charging control signal so that the battery voltage of the external battery has a constant level.

19. The method of claim 18, wherein the current limiting circuit limits the charging current in response to the charging control signal.

20. The method of claim 18, wherein, when the system voltage of the external system load connected to the charging control integrated circuit is lower than the battery voltage of the external battery, a discharging current is provided from the external battery to the system load.
